(19) United States
(12) Patent Application Publication
(10) Pub. No.: US 2022/0392194 A1
(43) Pub. Date: Dec. 8, 2022

(54) OBJECT DETECTION DEVICE

(71) Applicant: DENSO CORPORATION, Kariya-city (JP)

(72) Inventor: Keiko AKIYAMA, Kariya-city (JP)

(21) Appl. No.: 17/820,505

(22) Filed: Aug. 17, 2022

Related U.S. Application Data
(63) Continuation of application No. PCT/JP2021/005722, filed on Feb. 16, 2021.

(30) Foreign Application Priority Data
Feb. 18, 2020 (JP) 2020-025300
Feb. 8, 2021 (JP) 2021-018327

(51) Int. Cl. G06V 10/762; H04N 5/235; G06T 7/60; G06V 10/75; G01S 17/89

(52) U.S. Cl. CPC G06V 10/762; H04N 5/2354; H04N 5/2351; G06T 7/60; G06V 10/757; G01S 17/89; G06V 2201/07; G06T 2207/10028; G06T 2207/20021

(57) ABSTRACT

An object detection device includes an irradiation unit, a light reception unit and a detection unit. The light reception unit is configured to receive reflected light of light radiated by the irradiation unit and environment light. The detection unit is configured to detect a predetermined object based on a point group that is information based on the reflected light and at least one image. The point group is a group of reflection points detected in the whole distance measurement area. The at least one image includes an environment light image that is an image based on the environment light, a distance image that is an image based on a distance to an object detected on a basis of the reflected light and/or a reflection intensity image that is an image based on reflection intensity of the reflected light.

### CROSS-REFERENCE TO RELATED APPLICATION

This application is a continuation application of International Application No. PCT/JP2021/005722 filed Feb. 16, 2021 which designated the U.S. and claims priority to Japanese Patent Application No. 2020-25300 filed with the Japan Patent Office on Feb. 18, 2020 and Japanese Patent Application No. 2021-18327 filed with the Japan Patent Office on Feb. 8, 2021, the contents of each of which are incorporated herein by reference.

### BACKGROUND

### Technical Field

The present disclosure relates to an object detection device.

### Related Art

An object identification device is known that detects an object using a cluster generated by clustering a plurality of detection points detected by a laser radar. Specifically, the known object identification device specifies a cluster representing an object by calculating a degree of match between a cluster generated previous time and a cluster generated this time. In this event, the object identification device calculates a degree of match from a cluster of a root node to a cluster of a child node by utilizing a tree structure of clusters.

### BRIEF DESCRIPTION OF THE DRAWINGS

In the accompanying drawings:

FIG. 1 is a block diagram illustrating a configuration of an object detection device;

FIG. 2 is an example of a schematic view of an image target indicating a pedestrian;

FIG. 3 is an example of a schematic view of a portion indicating a pedestrian in a point group;

FIG. 4 is an example of a schematic view of an image target indicating a concrete mixer truck;

FIG. 5 is an example of a schematic view of a portion indicating a concrete mixer truck in a point group;

FIG. 6 is a flowchart indicating a first half of object detection processing of a first embodiment;

FIG. 7 is a flowchart indicating a latter half of the object detection processing of the first embodiment;

FIG. 8 is a flowchart indicating a first half of object detection processing of a second embodiment; and

FIG. 9 is a flowchart indicating object detection processing of a modification of the second embodiment.

### DESCRIPTION OF SPECIFIC EMBODIMENTS

As a result of detailed research performed by the present inventors, the following issues have been found. In other words, if clustering is performed only using a point group as in the device disclosed in JP 2013-228259 A, it is difficult to detect an object in correct unit. For example, in a case where a cluster smaller than a cluster that should be originally generated is generated as a cluster of a root node for an object to be detected, a cluster larger than the cluster of the root node is difficult to be detected as an object, and the cluster is overdivided. Further, for example, in a case where there is no cluster generated previous time, that is, upon first clustering, a degree of match between a cluster generated previous time and a cluster generated this time cannot be calculated, which makes it difficult to specify a cluster representing an object and degrades detection accuracy.

In view of the foregoing, it is desired to have an object detection device capable of detecting an object with higher accuracy in correct unit.

One aspect of the present disclosure is an object detection device including an irradiation unit, a light reception unit and a detection unit. The irradiation unit is configured to irradiate a predetermined distance measurement area with light. The light reception unit is configured to receive reflected light of the light radiated by the irradiation unit and environment light. The detection unit is configured to detect a predetermined object based on a point group that is information based on the reflected light and at least one image. The point group is a group of reflection points detected in the whole distance measurement area. The at least one image includes an environment light image that is an image based on the environment light, a distance image that is an image based on a distance to the object detected based on the reflected light and/or a reflection intensity image that is an image based on reflection intensity of the reflected light.

According to such a configuration, an object can be detected with higher accuracy in correct unit.

Illustrative embodiments of the present disclosure will be described below with reference to the drawings.

1. Configuration

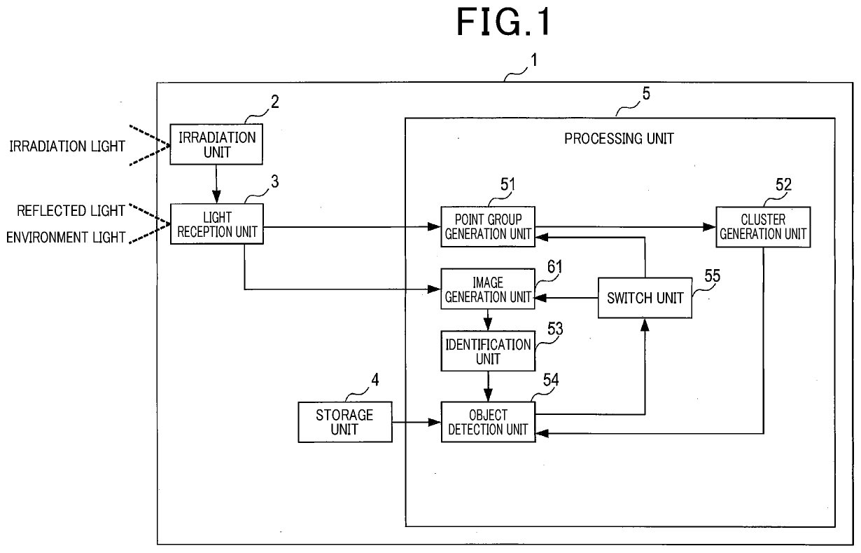

An object detection device 1 illustrated in FIG. 1, which is mounted on a vehicle and used, detects an object existing ahead of the vehicle by radiating light and receiving reflected light from the object that reflects the radiated light.

As illustrated in FIG. 1, the object detection device 1 includes an irradiation unit 2, a light reception unit 3, a storage unit 4 and a processing unit 5.

The irradiation unit 2 irradiates a distance measurement area ahead of the vehicle with laser light. The distance measurement area is an area expanding in a horizontal direction and in a vertical direction in a predetermined angle range. The irradiation unit 2 performs scanning with laser light in the horizontal direction.

The light reception unit 3 detects a light amount of incident light from the distance measurement area. The incident light detected by the light reception unit 3 includes environment light such as reflected light of solar light in addition to reflected light of laser light radiated by the irradiation unit 2, reflected at the object.

The distance measurement area is divided into a plurality of divided areas. In the distance measurement area, a light amount of incident light can be detected for each of the plurality of divided areas. In a case where the distance measurement area is represented as a two-dimensional plane that is visually confirmed when a portion ahead of the vehicle (that is, an irradiation direction of the laser light) is viewed from a viewpoint of the light reception unit 3, the above-described plurality of divided areas respectively correspond to areas obtained by dividing the two-dimensional plane into a plurality of steps in a horizontal direction and in a vertical direction. Each of the divided areas is a spatial area having a length along a line extending from the light reception unit 3 when the divided area is viewed as a three-dimensional space. The divided area is determined by an angle of the above-described line in the horizontal direction and an angle of the above-described line in the vertical direction being associated for each divided area.

In the present embodiment, the distance measurement area is divided into divided areas that are finer than areas of typical LIDAR in related art. For example, it is designed such that the number of divided areas in the distance measurement area becomes 500 in the horizontal direction and 100 in the vertical direction on the above-described two-dimensional plane.

One or more light reception elements are associated with each divided area. A size of the divided area (that is, a size of the area on the above-described two-dimensional plane) changes depending on the number of light reception elements to be associated with one divided area. As the number of light reception elements to be associated with one divided area is smaller, a size of one divided area becomes smaller and resolution becomes higher. To achieve such a configuration, the light reception unit 3 includes a light reception element array in which a plurality of light reception elements are arranged. The light reception element array is constituted with, for example, an SPAD and other photodiodes. Note that the SPAD is an abbreviation of single photon avalanche diode. As described above, the incident light includes reflected light and environment light. The reflected light that is laser light radiated by the irradiation unit 2 and reflected at an object is detected as a peak that can be sufficiently distinguished from the environment light in a received light waveform representing a relationship between time and a light amount of the incident light, which is obtained by sampling the light amount of the incident light for a fixed period from start time of an irradiation timing of laser light. A distance to a reflection point at which the laser light is reflected at the object is calculated from a period from the irradiation timing of the laser light by the irradiation unit 2 until a detection timing of the reflected light. Thus, a three-dimensional position of the reflection point is specified from angles of the divided area in the horizontal direction and in the vertical direction and a distance from the object detection device 1. The three-dimensional position of the reflection point is specified for each divided area, and thus, a three-dimensional position of a point group that is a group of reflection points detected in the whole distance measurement area is specified. In other words, a three-dimensional position and sizes in the horizontal direction and in the vertical direction in the three-dimensional space of the object that reflects the laser light are specified. Note that the three-dimensional position of the reflection point is converted into coordinate values of X, Y and Z for processing such as clustering which will be described later.

The environment light is detected as a received light waveform in a period during which the reflected light is not detected. For example, the received light waveform after a period set for detecting the reflected light of the laser light has elapsed may be detected as the environment light. As described above, the light reception unit 3 detects the light amount of the incident light from each divided area, so that a multiple tone grayscale image with resolution of 500 pixels in the horizontal direction×100 pixels in the vertical direction is generated based on the received environment light. In other words, an environment light image becomes an image similar to an image obtained by picking up an image of a portion ahead of the vehicle with a camera. In addition, angular positions of respective reflection points in the point group correspond to positions of respective pixels in the environment light image on a one-to-one basis, and thus, a correspondence relationship between an object recognized by analyzing the environment light image and an object recognized in the point group can be specified with high accuracy. Note that the environment light image is generated at an image generation unit 61 which will be described later.

The storage unit 4 stores type information, a distance threshold and a size threshold.

The type information refers to a type of an object to be detected. The object to be detected includes an object to which a driver should pay attention during driving, such as a pedestrian and a preceding vehicle.

The distance threshold is a threshold set for each type of the object as an indication of a distance range in which the object to be detected can be detected. For example, in a case where the object detection device 1 is extremely unlikely to be able to detect a pedestrian at a position away from the vehicle by equal to or greater than a predetermined distance due to performance of the object detection device 1, a driving environment, and the like, the predetermined distance is set as a distance threshold for a pedestrian. Note that the distance threshold to be used may be changed in accordance with a driving environment, and the like.

The size threshold is a threshold set for each type of an object as an indication of an appropriate size of the object to be detected. For example, in ranges of a possible height and a possible width of a pedestrian, upper limits of the ranges which indicate that if the ranges are exceeded, the object is extremely unlikely to be a pedestrian, are set as a size threshold for a pedestrian. By not setting lower limits, for example, even in a case where an image of only an upper body of a pedestrian is picked up, it is possible to determine the object as a pedestrian.

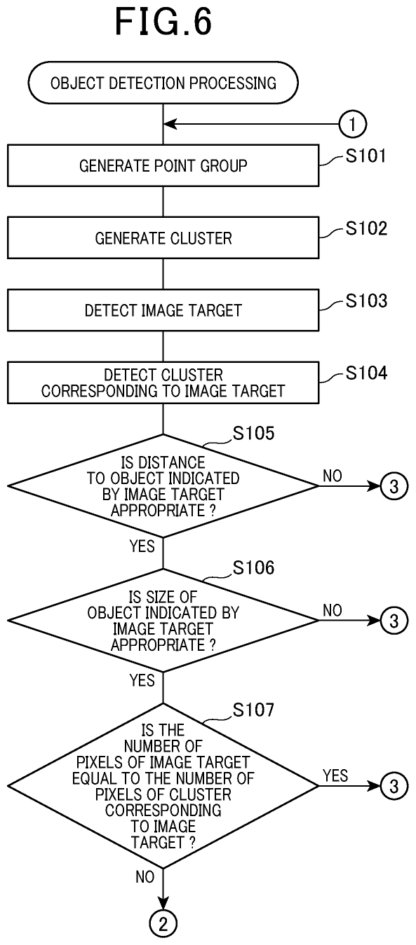

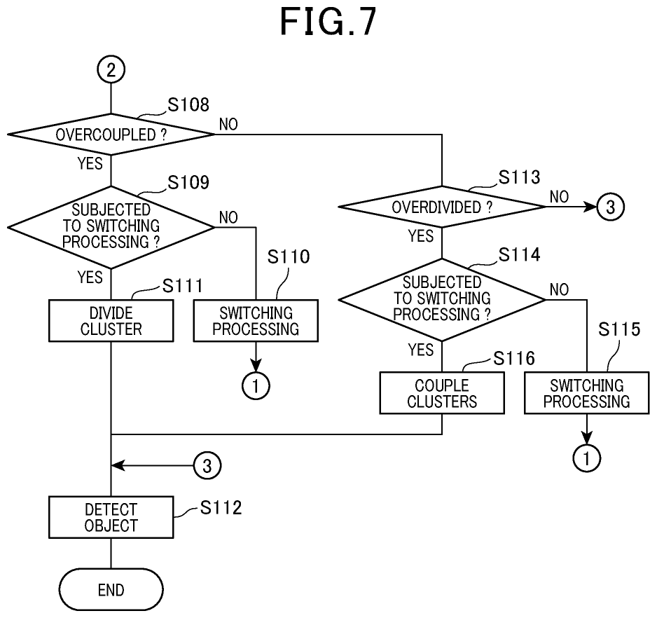

The processing unit 5 is mainly constituted with a well-known microcomputer including a CPU, a ROM, a RAM, a flash memory, and the like, which are not illustrated. The CPU executes a program stored in the ROM that is a non-transitory tangible recording medium. A method corresponding to the program is executed by the program being executed. Specifically, the processing unit 5 executes object detection processing illustrated in FIG. 6 and FIG. 7 which will be described later in accordance with the program. Note that the processing unit 5 may include one microcomputer or may include a plurality of microcomputers.

The processing unit 5 includes a point group generation unit 51, a cluster generation unit 52, an identification unit 53, an object detection unit 54, a switch unit 55 and an image generation unit 61 as functional blocks to be implemented by the CPU executing the program, that is, as virtual components. A method for implementing functions of the respective units included in the processing unit 5 is not limited to software, and part or all of the functions may be implemented using one or a plurality of pieces of hardware. For example, in a case where the above-described functions are implemented by an electronic circuit that is hardware, the electronic circuit may be implemented by a digital circuit, an analog circuit or a combination thereof.

The point group generation unit 51 generates a point group based on a received light waveform. The point group is a group of reflection points detected in the whole distance measurement area. The reflection point represents a point at which the laser light by the irradiation unit 2 is reflected and is acquired for each of the divided areas described above. By changing the number of light reception elements to be associated with one divided area, point group resolution can be switched in the point group. The point group resolution is the number of units (that is, divided areas) for detecting a plurality of reflection points that constitute the point group. The cluster generation unit 52 generates a plurality of clusters by clustering the point group generated by the point group generation unit 51.

The image generation unit 61 generates an environment light image, a distance image and a reflection intensity image. The distance image is an image representing for each pixel, a distance to the reflection point at which the laser light radiated by the irradiation unit 2 is reflected at the object. The reflection intensity image is an image representing for each pixel, intensity of light reception by the light reception unit 3, of the reflected light that is the laser light radiated by the irradiation unit 2 and reflected at the object. Resolution of each image can be switched.

The identification unit 53 analyzes the environment light image and detects an image target that is a portion identified as the object to be detected, in the environment light image. In other words, the identification unit 53 detects an object that matches the type information stored in the storage unit 4 from the environment light image. As a method for detecting an image target, for example, deep learning, machine learning, and the like, are used.

The object detection unit 54 detects a cluster corresponding to the image target detected by the identification unit 53 in the point group. Detection of the cluster corresponding to the image target will be described in detail later.

The switch unit 55 switches resolution as switching processing. Resolution in the vertical direction becomes higher by reducing the number of light reception elements to be used in one pixel and increasing the number of pixels in the vertical direction at the light reception unit 3. The object detection device 1 is constituted so as to be able to switch the resolution between first resolution in which light reception elements of a first number among a plurality of light reception elements are made one pixel, and second resolution in which light reception elements of a second number smaller than the first number among the plurality of light reception elements are made one pixel. In the present embodiment, the object detection device 1 is constituted so as to be able to switch the resolution between default resolution in which a total of 24 light reception elements of 6 in the horizontal direction×4 in the vertical direction are made one pixel, and high-level resolution in which a total of 12 light reception elements of 6 in the horizontal direction×2 in the vertical direction are made one pixel. On the other hand, resolution in the horizontal direction becomes higher by narrowing an interval at which scanning is performed with laser light and increasing the number of pixels in the horizontal direction at the irradiation unit 2. In the present embodiment, in a case of high-level resolution, an image with resolution of 1000 pixels in the horizontal direction×200 pixels in the vertical direction is generated as the environment light image. Further, in the present embodiment, the point group resolution is set so as to match the resolution of the image described above. Specifically, in a case of high-level resolution, the point group is generated as a group of reflection points detected in divided areas of 1000 in the horizontal direction×200 in the vertical direction.

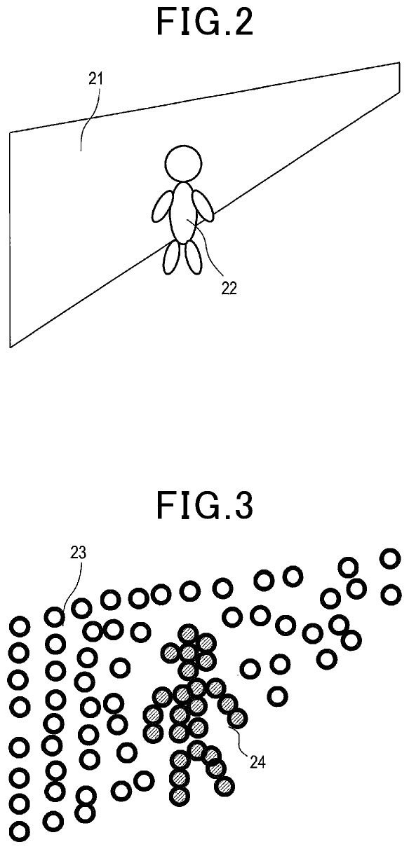

Here, an example of a scene in which a wall is close to a pedestrian will be described using FIG. 2 and FIG. 3. In the environment light image in FIG. 2, also in a case where a pedestrian 22 is detected as an image target separately from a wall 21, there is a case where the wall 23 and the pedestrian 24 are not distinguished and detected as one cluster in the point group in FIG. 3. Here, a state where a plurality of clusters that should be distinguished in object unit are coupled into one cluster will be referred to as overcoupling of clusters.

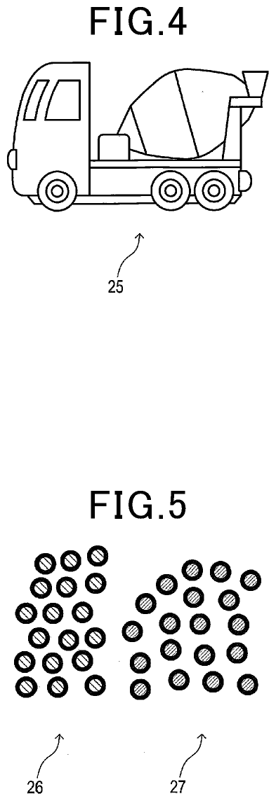

Further, an example of a concrete mixer truck will be described using FIG. 4 and FIG. 5. As illustrated in FIG. 4, also in a case where a concrete mixer truck 25 is detected as an image target in the environment light image, there is a case where a front portion 26 and a tank portion 27 in a vehicle body of the concrete mixer truck are detected as two clusters in the point group in FIG. 5. Here, a state where one cluster that should be distinguished in object unit is divided into a plurality of clusters will be referred to as overdivision of a cluster.

In other words, in the scenes illustrated in FIG. 2 to FIG. 5, even if the object can be detected in correct unit in the environment light image, there is a case where it is difficult to detect the object in correct unit in the point group.

Inversely, even if an object can be detected in correct unit in the point group, there is also a case where it is difficult to detect the object in correct unit in the environment light image. For example, there is a case where part of a wall having a patchy pattern, an arrow painted on a road surface, or the like, is detected as the image target indicating a pedestrian in the environment light image.

Thus, the object detection device 1 of the present embodiment executes object detection processing that improves detection accuracy of an object by utilizing both an environment light image and a point group.

2. Processing

The object detection processing to be executed by the processing unit 5 of the object detection device 1 will be described using flowcharts in FIG. 6 and FIG. 7. The object detection processing is executed every time distance measurement for the whole distance measurement area is completed. Note that at the beginning of the object detection processing, the default resolution is set as the resolution. Note that in the description of the present processing, the resolution when simply described includes both resolution of an image and point group resolution of a point group.

First, in S101, the processing unit 5 generates a point group. Note that the processing in S101 corresponds to processing as the point group generation unit 51.

Subsequently, in S102, the processing unit 5 generates a plurality of clusters by clustering the point group. The generated each cluster does not have type information as an initial value. Note that the processing in S102 corresponds to processing as the cluster generation unit 52.

Subsequently, in S103, the processing unit 5 detects an image target from the environment light image. As a result of the image target being detected, a type of the image target is also recognized. In a case where there are a plurality of objects to be detected in the environment light image, the processing unit 5 detects a plurality of image targets from the environment light image. The subsequent processing is executed for each image target. Note that in a case where an image target is not detected in S103 although the cluster is generated in S102, the processing transitions to S112, and the processing unit 5 detects each generated cluster as an object and ends the object detection processing in FIG. 6. In this event, each generated cluster is detected as an object not having type information. Note that the processing in S103 corresponds to processing as the identification unit 53.

Subsequently, in S104, the processing unit 5 detects a cluster corresponding to the image target. Specifically, first, the processing unit 5 encloses the image target detected in S103 with a rectangle in the environment light image. In addition, the processing unit 5 encloses the plurality of clusters generated in S102 in the point group respectively with rectangles while regarding the point group as a two-dimensional plane having information of angular positions of the respective reflection points. Then, the processing unit 5 detects a rectangle of the cluster that overlaps with the rectangle of the image target and detects the cluster as the cluster corresponding to the image target. Here, in a case where there are a plurality of rectangles of clusters that overlap with the rectangle of the image target, the processing unit 5 detects a rectangle of a cluster with the highest overlapping ratio with the rectangle of the image target and detects the cluster as the cluster corresponding to the image target. In other words, the processing unit 5 associates the image target with the cluster. Note that in a case where there is no rectangle of a cluster that overlaps with the rectangle of the image target, the processing unit 5 invalidates the image target and ends the object detection processing in FIG. 6.

Subsequently, in S105, the processing unit 5 determines whether a distance to the object indicated by the image target is appropriate. Specifically, the processing unit 5 determines that the distance is appropriate in a case where the distance to the object indicated by the image target is equal to or less than the distance threshold. While determination as to whether the distance to the object is appropriate cannot be performed only with the environment light image, the determination can be performed by using the point group having information of the distances to the reflection points. In other words, the image target is associated with the cluster, and thus, for example, a distance between a center point of the cluster corresponding to the image target and the object detection device 1 can be used as the distance between the image target and the object detection device 1. Note that in the following description, the pixel or the number of pixels of the cluster corresponding to the image target means the divided area or the number of divided areas that is a unit for detecting a plurality of reflection points that constitute the point group.

In a case where it is determined in S105 that the distance to the object indicated by the image target is appropriate, the processing transitions to S106, and the processing unit 5 determines whether a size of the object indicated by the image target is appropriate. Specifically, in a case where the size of the object indicated by the image target falls within the size threshold, the processing unit 5 determines that the size is appropriate. While determination as to whether the size of the object is appropriate cannot be performed only with the environment light image, the determination can be performed by using the point group having information of the three-dimensional positions of the reflection points. The size of the object indicated by the image target is estimated based on a portion in the point group, corresponding to the image target. The portion in the point group, corresponding to the image target is a portion at an angular position corresponding to the position of each pixel of the image target in the point group. For example, in a case where the number of pixels of the cluster corresponding to the image target is larger than the number of pixels of the image target, the size of the portion in the point group, corresponding to the image target among the cluster corresponding to the image target is estimated as the size of the object indicated by the image target. Further, for example, in a case where the number of pixels of the cluster corresponding to the image target is smaller than the number of pixels of the image target, the size of the cluster obtained by multiplying the cluster corresponding to the image target by a ratio of the number of pixels of the image target to the number of pixels of the cluster corresponding to the image target is estimated as the size of the object indicated by the image target.

In a case where it is determined in S106 that the size of the object indicated by the image target is appropriate, the processing transitions to S107, and the processing unit 5 determines whether the number of pixels of the image target is equal to the number of pixels of the cluster corresponding to the image target. Specifically, the processing unit 5 determines that the number of pixels of the image target is equal to the number of pixels of the cluster corresponding to the image target in a case where a difference obtained by subtracting the number of pixels of the image target from the number of pixels of the cluster corresponding to the image target falls within a range between a lower limit value and an upper limit value of a threshold for the number of pixels indicating a range of a predetermined number of pixels. For example, in a case where the threshold for the number of pixels indicates a range of ±10 pixels, the upper limit value indicates+10, and the lower limit value indicates −10.

In a case where it is determined in S107 that the number of pixels of the image target is not equal to the number of pixels of the cluster corresponding to the image target, the processing transitions to S108, and the processing unit 5 determines whether the clusters are overcoupled. Whether the clusters are overcoupled is determined in accordance with whether the portion in the point group, corresponding to the image target includes an overcoupled cluster that is a cluster larger than the portion in the point group, corresponding to the image target. For example, in a case where a difference obtained by subtracting the number of pixels of the image target from the number of pixels of the cluster corresponding to the image target is greater than the upper limit value of the threshold for the number of pixels, it is determined that there is an overcoupled cluster. In a case where there is an overcoupled cluster, the processing unit 5 determines that the clusters are overcoupled.

In a case where it is determined in S108 that the clusters are overcoupled, the processing transitions to S109, and the processing unit 5 determines whether the switching processing has been performed. In the present embodiment, the processing unit 5 determines whether the resolution has been switched. Note that the processing of switching the resolution is executed in S110 or S115 which will be described later.

In a case where it is determined in S109 that the resolution has not been switched, the processing transitions to S110, the processing unit 5 performs the switching processing, that is, switches the resolution to high-level resolution, and then the processing returns to S101. In other words, the processing unit 5 executes the processing from S101 to S108 again in a state where the resolution of the image and the point group is higher.

On the other hand, in a case where it is determined in S109 that the resolution has been switched, the processing of the processing unit 5 transitions to S111. In other words, the processing unit 5 executes the processing from S101 to S108 again in a state where the resolution of the image and the point group is higher, and the processing transitions to S111 in a case where it is still determined that the clusters are overcoupled.

The processing unit 5 divides the overcoupled cluster in S111. The processing unit 5 divides the overcoupled cluster so that a shortest distance between a target cluster that is a portion corresponding to the image target among the overcoupled cluster and an adjacent cluster that is a portion except the portion corresponding to the image target among the overcoupled cluster becomes greater than a maximum distance among distances between two adjacent points in the target cluster and becomes greater than a maximum distance among distances between two adjacent points in the adjacent cluster. Note that the processing unit 5 may divide the portion corresponding to the image target in the overcoupled cluster as is to make one cluster.

Subsequently, the processing unit 5 detects the cluster of the portion in the point group, corresponding to the image target as the object in S112. In other words, in a case where it is determined in S108 that the clusters are overcoupled, and the overcoupled cluster is divided in S111, the processing unit 5 detects the cluster of the portion corresponding to the image target among the overcoupled cluster as an object having type information. In addition, the processing unit 5 detects the adjacent cluster divided from the overcoupled cluster as an object not having type information in S112. Then, the processing unit 5 ends the object detection processing in FIG. 6.

On the other hand, in a case where it is determined in S108 that the clusters are not overcoupled, the processing transitions to S113, and the processing unit 5 determines whether the cluster is overdivided. Whether the cluster is overdivided is determined in accordance with whether the portion in the point group, corresponding to the image target includes two or more clusters. Specifically, in a case where the difference obtained by subtracting the number of pixels of the image target from the number of pixels of the cluster corresponding to the image target is less than the lower limit value of the threshold for the number of pixels and the portion in the point group, corresponding to the image target includes one or more clusters other than the cluster corresponding to the image target, the processing unit 5 determines that the cluster is overdivided.

In a case where it is determined in S113 that the cluster is overdivided, the processing transitions to S114, and the processing unit 5 determines whether the switching processing has been performed. In the present embodiment, the processing unit 5 determines whether the resolution has been switched.

In a case where it is determined in S114 that the resolution has not been switched, the processing transitions to S115, the processing unit 5 performs the switching processing, that is, switches the resolution to high-level resolution, and then, the processing returns to S101. In other words, the processing unit 5 executes the processing from S101 to S108 and S113 again in a state where the resolution of the image and the point group is higher. Note that the processing in S110 and S115 corresponds to processing as the switch unit 55.

On the other hand, in a case where it is determined in S114 that the resolution has been switched, the processing of the processing unit 5 transitions to S116. In other words, the processing unit 5 executes the processing from S101 to S108 and S113 again in a state where the resolution of the image and the point group is higher, and the processing transitions to S116 in a case where it is still determined that the cluster is overdivided.

The processing unit 5 couples two or more clusters existing in the portion in the point group, corresponding to the image target in S116, and the processing transitions to S112. In other words, in a case where two or more clusters are coupled in S116, the processing unit 5 detects the coupled cluster as an object having type information. The processing unit 5 then ends the object detection processing in FIG. 6.

In a case where it is determined in S113 that the cluster is not overdivided, the processing transitions to S112, and the processing unit 5 detects the cluster corresponding to the image target as the object and then ends the object detection processing in FIG. 6. In this event, the cluster corresponding to the image target is detected as an object not having type information. Note that even in a case where it is determined in S113 that the cluster is not overdivided, in a case where there are a plurality of rectangles of clusters that overlap with the rectangle of the image target in S104, the processing unit 5 repeats the processing in and after S105 while setting a cluster with the next highest overlapping ratio with the rectangle of the image target as the cluster corresponding to the image target.

On the other hand, in a case where it is determined in S107 that the number of pixels of the image target is equal to the number of pixels of the cluster corresponding to the image target, the processing transitions to S112, and the processing unit 5 detects the cluster corresponding to the image target that is the cluster of the portion in the point group, corresponding to the image target, as an object having type information and then ends the object detection processing in FIG. 6. This indicates that the number of pixels of the cluster corresponding to the image target is substantially equal to the number of pixels of the image target, and the cluster corresponding to the image target is neither overdivided nor overcoupled. In other words, this indicates that the object indicated by the image target and the cluster of the portion in the point group, corresponding to the image target are both detected in correct unit.

On the other hand, in a case where it is determined in S106 that the size of the object indicated by the image target is not appropriate, the processing unit 5 invalidates the target image. Further, after the processing transitions to S112, and the processing unit 5 detects the object corresponding to the image target as an object, the processing unit 5 ends the object detection processing in FIG. 6. In this event, the cluster corresponding to the image target is detected as an object not having type information.

Further, also in a case where it is determined in S105 that the distance to the object indicated by the image target is not appropriate, the processing unit 5 invalidates the target image. Further, after the processing transitions to S112, and the processing unit 5 detects the cluster corresponding to the image target as an object, the processing unit 5 ends the object detection processing in FIG. 6. In this event, the cluster corresponding to the image target is detected as an object not having type information. Note that the processing from S104 to S108, S111 to S113 and S116 corresponds to processing as the object detection unit 54.

3. Effects

According to the embodiment described in detail above, the following effects can be obtained.

(3a) The object detection device 1 detects a predetermined object based on a point group and an environment light image. According to such a configuration, it is easier to detect a type and a unit of the object in the point group than in a case where a predetermined object is detected in a point group without utilizing an environment light image. Further, an object can be detected with equal accuracy upon initial distance measurement and upon second and after distance measurement compared to a case where an object is detected by calculating a degree of match between a cluster generated previous time and a cluster generated this time. Thus, according to the object detection device 1, an object can be detected with higher accuracy in correct unit.

(3b) In a case where it is determined that a portion in a point group, corresponding to an image target includes two or more clusters among a plurality of clusters generated by clustering the point group, the object detection device 1 detects the two or more clusters as one object. According to such a configuration, even in a case where a cluster is overdivided in a point group, the object detection device 1 can detect an object in correct unit.

(3c) In a case where it is determined that a portion in a point group, corresponding to an image target includes an overcoupled cluster with a larger size than a size of the portion in the point group, corresponding to the image target among a plurality of clusters generated by clustering the point group, the object detection device 1 detects the portion corresponding to the image target among the overcoupled cluster as an object. According to such a configuration, even in a case where clusters are overcoupled in a point group, the object detection device 1 can detect an object in correct unit.

(3d) The object detection device 1 divides the overcooled cluster so that a shortest distance between a target cluster that is a portion corresponding to an image target among the overcoupled cluster and an adjacent cluster that is a portion except the portion corresponding to the image target among the overcoupled cluster becomes greater than a maximum distance among distances between two adjacent points in the target cluster and becomes greater than a maximum distance among distances between two adjacent points in the adjacent cluster. According to such a configuration, the object detection device 1 can detect an object in correct unit compared to a case where a portion corresponding to an image target among an overcoupled cluster is divided as is to make one cluster.

(3e) In a case where it is determined that a size of an object falls within a range of a size set in advance in accordance with a type of the object indicated by an image target, the object detection device 1 detects a portion in a point group, corresponding to the image target as an object. In other words, the object detection device 1 verifies a likelihood of an object based on a size assumed for each type of an object. In this event, the object detection device 1 identifies a type of an object using the environment light image and calculates a size of the object using the point group. By using the point group in combination as well as the environment light image, the object detection device 1 can prevent a type of an object from being erroneously identified.

(3f) In a case where it is determined that a distance to an object falls within a range of a distance set in advance in accordance with a type of an object indicated by an image target, the object detection device 1 detects a portion in a point group, corresponding to the image target as an object. In other words, the object detection device 1 verifies a likelihood of an object based on an assumed position of an object for each type of an object. In this event, the object detection device 1 identifies a type of an object using the environment light image and calculates a distance to the object using the point group. By using the point group in combination as well as the environment light image, the object detection device 1 can prevent a type of an object from being erroneously identified.

(3g) In the object detection device 1, the light reception unit 3 includes a plurality of light reception elements. The object detection device 1 can switch the resolution between first resolution in which light reception elements of a first number among a plurality of light reception elements are made one pixel and second resolution in which light reception elements of a second number smaller than the first number among the plurality of light reception elements are made one pixel. According to such a configuration, the object detection device 1 can detect an object with higher accuracy than in a case where the resolution cannot be switched between the first resolution and the second resolution.

Note that in the present embodiment, the point group generation unit 51, the cluster generation unit 52, the identification unit 53, the object detection unit 54 and the image generation unit 61 correspond to processing as a detection unit.

### 4. Second Embodiment

4-1. Differences from First Embodiment A second embodiment is similar to the first embodiment in a basic configuration and processing, and thus, description regarding a common configuration and processing will be omitted, and differences will be mainly described.

In the first embodiment, the object detection device 1 detects an image target only from the environment light image in S103 of the object detection processing. On the other hand, in the second embodiment, the object detection device 1 detects image targets respectively from the environment light image, the distance image and the reflection intensity image. Further, in the second embodiment, the object detection device 1 switches resolution of the point group, the environment light image, the distance image and the reflection intensity image in accordance with outside brightness.

4-2. Processing

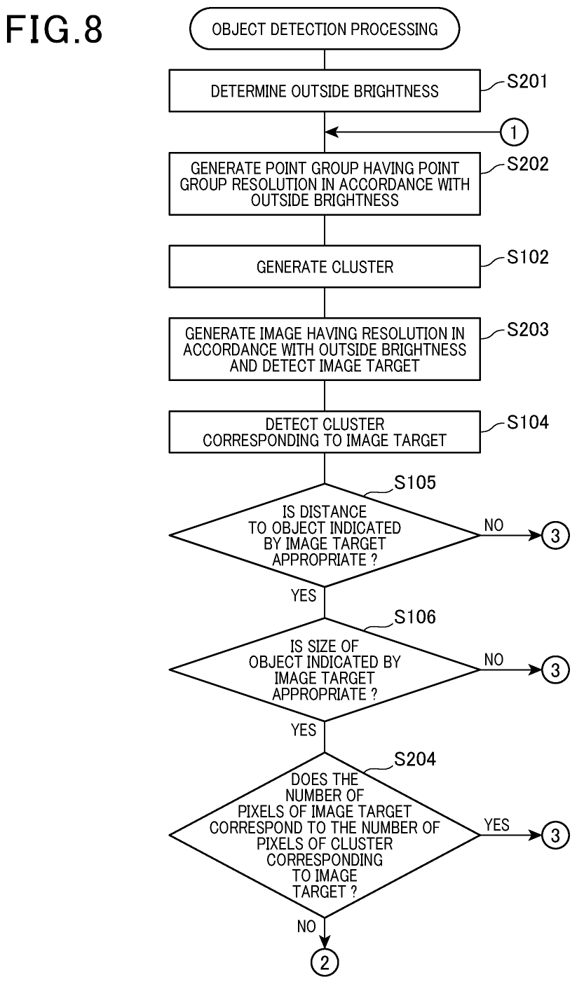

Object detection processing to be executed by the processing unit 5 of the object detection device 1 of the second embodiment will be described using the flowchart in FIG. 8.

In S201, the processing unit 5 determines whether outside brightness is brighter than a predetermined threshold. For example, the processing unit 5 determines that outside is bright in a case where intensity of the environment light is equal to or greater than a predetermined threshold.

In S202, the processing unit 5 generates a point group having point group resolution in accordance with outside brightness. Specifically, the processing unit 5 generates a point group having relatively lower point group resolution in a case where it is determined in S201 that the outside brightness is brighter than the predetermined threshold than in a case where it is determined in S201 that the outside brightness is not brighter than the predetermined threshold. On the other hand, in a case where it is determined in S201 that the outside brightness is not brighter than the predetermined threshold, the processing unit 5 generates a point group having relatively high point group resolution. The point group resolution matches the resolution of the distance image and the reflection intensity image generated in S203.

Subsequently, in S102, the processing unit 5 generates a plurality of clusters by clustering the point group.

Subsequently, in S203, the processing unit 5 generates an image having resolution in accordance with outside brightness. Specifically, the processing unit 5 generates an environment light image having relatively higher resolution and generates a distance image and a reflection intensity image having relatively lower resolution in a case where it is determined in S201 that the outside brightness is brighter than the predetermined threshold than in a case where it is determined in S201 that the outside brightness is not brighter than the predetermined threshold. On the other hand, in a case where it is determined in S201 that the outside brightness is not brighter than the predetermined threshold, the processing unit 5 generates an environment light image having relatively low resolution and generates a distance image and a reflection intensity image having relatively high resolution.

Further, in S203, the processing unit 5 detects image targets respectively from the environment light image, the distance image and the reflection intensity image and integrates the image targets. Integration refers to generation of one image target to be used in processing to be performed subsequent to S203 based on the image targets detected using three types of images. For example, in a case where an image target is detected from one of the three types of images, the processing unit 5 employs the image target as the image target. Note that a method for integrating the image targets is not limited to this. For example, it is also possible to prevent the image target detected only from one of the three types of images from being employed as the image target. In other words, in this case, the processing proceeds assuming that the image target is not detected. Further, for example, it is also possible to prevent the image target detected only from two of the three types of images from being employed as the image target. Further, in a case where different image targets are detected from the three types of images, the image target may be determined based on priority determined in advance for each image, or the image targets detected from two images may be integrated as the image target. After S203, the processing proceeds to S104. The processing from S104 to S106 is similar to the processing from S104 to S106 illustrated in FIG. 6.

In a case where it is determined in S106 that the size of the object indicated by the image target is appropriate, the processing transitions to S204, and the processing unit 5 determines whether the number of pixels of the image target corresponds to the number of pixels of the cluster corresponding to the image target.

In S107 in the first embodiment described above, the processing unit 5 compares the number of pixels of the cluster corresponding to the image target with the number of pixels of the image target to compare the size of the image target with the size of the cluster corresponding to the image target. However, in the second embodiment, there is a case where the point group resolution is different from the resolution of the image, and thus, the number of pixels cannot be simply compared. Thus, a ratio between the point group resolution and the resolution of the image is obtained based on the point group resolution of the point group generated in S202 and the resolution of the image generated in S203. For example, if the resolution of the image is 500 pixels in the horizontal direction×200 pixels in the vertical direction, and the point group resolution is 1000 pixels in the horizontal direction×200 pixels in the vertical direction, an area of one pixel of the image is double an area of one pixel of the point group. In this case, if the number of pixels of the image target is double the number of pixels of the cluster corresponding to the image target, the cluster corresponding to the image target and the image target have a size in the same range in the distance measurement area. The above-described ratio is obtained in this manner, and whether the size of the image target is equal to the size of the cluster corresponding to the image target is obtained in view of the ratio. Note that the above-described method is an example, and in a case where the number of pixels of the cluster corresponding to the image target is different from the number of pixels of the image target, various methods capable of comparing the size can be used.

In a case where it is determined in S204 that the number of pixels of the image target does not correspond to the number of pixels of the cluster corresponding to the image target, the processing of the processing unit 5 transitions to S108. On the other hand, in a case where it is determined that the number of pixels of the image target corresponds to the number of pixels of the cluster corresponding to the image target, the processing transitions to S112. The processing in and after S108 is similar to the processing from S108 to S116 illustrated in FIG. 7, and thus, description will be omitted.

4-3. Effects

According to the second embodiment described in detail above, the following effects can be obtained.

(4a) In a case where it is determined that outside brightness is bright, the object detection device 1 detects an object based on an environment light image having relatively higher resolution and a distance image and a reflection intensity image having relatively lower resolution than in a case where it is determined that outside brightness is not bright. According to such a configuration, in the environment light image, the image target is detected from the environment light image with high resolution, so that image recognition accuracy becomes high. Further, in the distance image and the reflection intensity image, an SN is improved, so that a detection distance tends to extend. It is therefore possible to detect an object at a farther position. Note that the SN refers to a signal-to-noise ratio.

(4b) In a case where it is determined that the outside brightness is not bright, the object detection device 1 detects an object based on an environment light image having relatively lower resolution and a distance image and a reflection intensity image having relatively higher resolution than in a case where it is determined that the outside brightness is bright. According to such a configuration, reliability of the environment light image in a case where outside is not bright is low in the first place, and thus, the reliability is less likely to be affected even if the resolution of the environment light image is lowered. It is therefore possible to generate an environment light image while reducing processing load. Further, in the distance image and the reflection intensity image, noise becomes less in a case where intensity of the environment light is low, and thus, a detection distance tends to become long. It is therefore possible to prevent the detection distance from becoming shorter even if the resolution is increased.

(4c) In the object detection device 1, the point group resolution matches the resolution of the distance image and the reflection intensity image. According to such a configuration, angular positions of respective reflection points in the point group correspond to positions of respective pixels in the distance image and the reflection intensity image on a one-to-one basis, and thus, an object recognized by analyzing the distance image and the reflection intensity image can be easily associated with an object recognized in the point group.

(4d) In the object detection device 1, the processing unit 5 generates a point group having point group resolution in accordance with the outside brightness in S202 and generates an image having resolution in accordance with the outside brightness in S203. In addition, in a case where it is determined in S108 that the clusters are overcoupled, the processing unit 5 switches the resolution to high-level point group resolution and high-level resolution in S110. Also in a case where it is determined in S113 that the cluster is overdivided, the processing unit 5 switches the resolution to high-level point group resolution and high-level resolution in S115. According to such a configuration, an object can be detected with higher accuracy in a similar manner to the first embodiment.

Note that in the present embodiment, the processing in S201 corresponds to processing as a determination unit.

4-4. Modifications of Second Embodiment

(i) In the above-described embodiment, an object is detected based on three types of images of the environment light image, the distance image and the reflection intensity image. However, the number of types of images to be used is not limited to this. For example, at least one of the environment image, the distance image or the reflection intensity image may be used. Further, the environment light image and at least one of the distance image or the reflection intensity image may be used.

(ii) In the above-described embodiment, resolution of the environment light image is relatively higher and point group resolution of the point group is relatively lower in a case where it is determined that outside brightness is bright than in a case where it is determined that outside brightness is not bright. Further, resolution of the environment light image is relatively lower and point group resolution of the point group is relatively higher in a case where it is determined that outside brightness is not bright than in a case where it is determined that outside brightness is bright. In other words, in a case where the point group resolution of the point group is low, the resolution of the environment light image is set at relatively high resolution, and in a case where the point group resolution of the point group is high, the resolution of the environment light image is set at relatively low resolution. However, a method for setting the point group resolution and the resolution is not limited to this. For example, the resolution of the environment light image may be switched to high resolution or low resolution while the point group resolution of the point group is kept constant, or the point group resolution of the point group may be switched to high resolution or low resolution while the resolution of the environment light image is kept constant. Further, for example, in a case where the point group resolution of the point group is low, the resolution of the environment light image may also be switched to low resolution, or in a case where the point group resolution of the point group is high, the resolution of the environment light image may also be switched to high resolution.

Further, concerning the distance image and the reflection intensity image, for example, the resolution of the distance image and the reflection intensity image may be switched to high resolution or low resolution while the point group resolution of the point group is kept constant, or the point group resolution of the point group may be switched to high resolution or low resolution while the resolution of the distance image and the reflection intensity image is kept constant in a similar manner. Further, for example, in a case where the point group resolution of the point group is low, the resolution of the distance image and the reflection intensity image may also be switched to low resolution, or in a case where the point group resolution of the point group is high, the resolution of the distance image and the reflection intensity image may also be switched to high resolution.

According to such a configuration, the point group resolution of the point group and the resolution of the image can be independently set at appropriate values.

(iii) In the above-described embodiment, the resolution of the environment light image is different from the resolution of the distance image and the reflection intensity image. In other words, an object is detected based on the environment light image having third resolution and the distance image and the reflection intensity image having fourth resolution different from the third resolution. However, the resolution of the environment light image may match the resolution of the distance image and the reflection intensity image. According to such a configuration, image targets detected from the respective images can be easily associated with one another.

(iv) In the above-described embodiment, the point group resolution matches the resolution of the distance image and the reflection intensity image. However, the resolution of the point group does not have to match the resolution of the distance image and the reflection intensity image or may match resolution of one of the distance image and the reflection intensity image.

(v) In the above-described embodiment, the point group and the image having resolution in accordance with outside brightness are generated. However, the resolution of the point group and the image may be set in accordance with requirements other than outside brightness. For example, the resolution may be set in accordance with time, whether a headlight is turned on, an attribute of a road on which the vehicle travels, and the like.

(vi) In the above-described embodiment, outside brightness is determined based on intensity of the environment light. However, a method for determining outside brightness is not limited to this. For example, an illuminance sensor may be used.

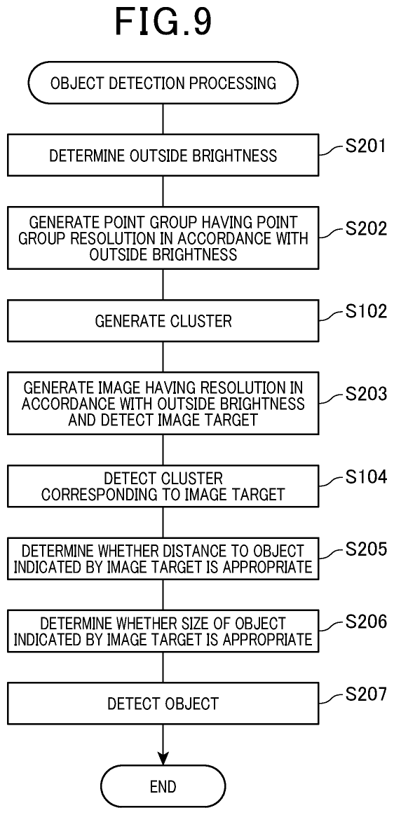

(vii) In the above-described embodiment, the processing unit 5 divides the cluster in a case where the clusters are overcoupled and couples the clusters in a case where the cluster is overdivided through the processing from S107 to S111 and from S113 to S116. However, the processing unit 5 does not have to divide or couple the clusters described above. For example, as illustrated in FIG. 9, the processing unit 5 detects a cluster corresponding to the image target in S104 and then determines whether a distance to an object indicated by the image target is appropriate in S205. Specifically, the processing unit 5 performs determination in a similar manner to S105 in FIG. 6.

Subsequently, in S206, the processing unit 5 determines whether a size of the object indicated by the image target is appropriate. Specifically, the processing unit 5 performs determination in a similar manner to S106 in FIG. 6.

Subsequently, in S207, the processing unit 5 detects an object. In this event, in a case where it is determined in S205 that the distance to the object indicated by the image target is appropriate and it is determined in S206 that the size of the object indicated by the image target is appropriate, the cluster corresponding to the image target is detected as an object having type information. Then, the processing unit 5 ends the object detection processing in FIG. 9.

On the other hand, in S207, in a case where it is determined in S205 that the distance to the object indicated by the image target is not appropriate or in a case where it is determined in S206 that the size of the object indicated by the image target is not appropriate, the cluster corresponding to the image target is detected as an object not having type information. Then, the processing unit 5 ends the object detection processing in FIG. 9.

Further, returning to FIG. 7, for example, the processing unit 5 may skip the processing in S109 and S110 after determining whether the clusters are overcoupled in S108. Further, the processing unit 5 may skip the processing in S114 and S115 after determining whether the cluster is overdivided in S113. In other words, the processing unit 5 may divide or couple the clusters and detect the cluster as an object having type information without performing switching processing.

### 5. Other Embodiments

While the embodiments of the present disclosure have been described above, it goes without saying that the present disclosure is not limited to the above-described embodiments and can take various forms.

(5a) In the above-described embodiments, an example of a configuration where an SPAD is provided as a light reception element has been described. However, any kind of light reception element may be used if a temporal change of a light amount of incident light can be detected.

(5b) In the above-described first embodiment, an example of a configuration where the environment light image is used has been described. However, a type of the image to be used is not limited to this. For example, at least one of the distance image or the reflection intensity image may be used in addition to or in place of the environment light image. Note that both the distance image and the reflection intensity image are generated in accordance with the number of divided areas, and thus, angular positions of respective reflection points in the point group correspond to positions of respective pixels in the distance image and the reflection intensity image on a one-to-one basis. This results in enabling a correspondence relationship between an object recognized by analyzing the distance image and the reflection intensity image and an object recognized in the point group to be specified with high accuracy.

Here, in a case where the environment light image is used, while detection performance is high in the daytime of sunny day, there is a case where detection performance is lowered during night-time, in a tunnel, or the like. On the other hand, in a case where the distance image and the reflection intensity image are used, characteristics opposite to the characteristics are exhibited. Thus, the object detection device 1 can detect an object with higher accuracy in correct unit by using these images in combination.

(5c) In the above-described embodiment, in a case where there is a possibility that a cluster is overdivided or clusters are overcoupled, distance measurement is executed again for the whole distance measurement area after the resolution is switched. However, a range in which distance measurement is to be executed again is not limited to this. The object detection device 1 may execute distance measurement again only in part of a range in the distance measurement area, for example, in a range in which there is a possibility that clusters are overcoupled or a cluster is overdivided. This can prevent excessive detection of an object in a range in which switching of the resolution is unnecessary, so that it is possible to prevent delay of a detection timing.

(5d) In the above-described embodiment, an example of a configuration where the resolution is switched between the first resolution and the second resolution by switching the number of light reception elements per pixel has been described. However, the object detection device 1 may switch the resolution by switching a range of the distance measurement area. Specifically, an angular range in a horizontal direction of laser light radiated by the irradiation unit 2 is switched. For example, the object detection device 1 switches the angular range from −60° to +60° to −20° to +20° without changing the number of divided areas. If the angular range is narrowed without the number of divided areas being changed, the number of divided areas in the angular range becomes relatively larger, and the resolution becomes relatively higher. It is therefore possible to generate a more precise point group. Further, also in the environment light image, one-third range is expressed without the number of pixels being changed, so that the resolution becomes relatively higher.

Further, the object detection device 1 may improve an SN by switching the number of times that each divided area is irradiated with laser light from a first number of times of irradiation to a second number of times of irradiation larger than the first number of times of irradiation in addition to or in place of switching the resolution as the switching processing. The number of times of irradiation of laser light is each number of times that the object detection device 1 irradiates each of the divided areas with laser light during one cycle of distance measurement in the distance measurement area. Note that in the above-described embodiments, the first number of times of irradiation is set at one, and each divided area is irradiated with laser light once. According to such a configuration, for example, as in FIG. 5, also in a case where a concrete mixer truck is detected as two clusters of the front portion 26 and the tank portion 27, the object detection device 1 can easily detect a portion in a vehicle body, which connects the front portion 26 and the tank portion 27 by increasing the SN. This enables the object detection device 1 to detect the concrete mixer truck as one cluster instead of two clusters.

Note that while in the above-described embodiments, the whole distance measurement area is set as a range in which laser light is to be radiated, if the number of times that each divided area is irradiated with laser light is increased, a detection period becomes longer, which may result in delaying an object detection timing. Thus, the object detection device 1 may limit switching of the number of times of irradiation from the first number of times of irradiation to the second number of times of irradiation in part of a range of the distance measurement area, for example, in a range in which there is a possibility that clusters are overcoupled or a cluster is overdivided. This enables the object detection device 1 to detect an object with higher accuracy in correct unit while preventing delay of an object detection timing.

(5e) In the above-described embodiments, an example of a configuration where only the upper limit value is set as the size threshold has been described. However, a lower limit value in addition to or in place of the upper limit value may be set as the size threshold.

(5f) In the above-described embodiments, the object detection device 1 determines that there is an overcoupled cluster in a case where the number of pixels of the cluster corresponding to the image target is larger than the number of pixels of the image target by equal to or greater than a predetermined number of pixels. However, for example, the object detection device 1 may determine whether there is an overcoupled cluster by comparing the number of all points that is the number of all points that constitute a cluster existing in a portion in the point group, corresponding to the image target with the number of partial points that is the number of points of reflection points in a portion corresponding to the image target. Further, for example, the object detection device 1 may determine that there is an overcoupled cluster in a case where a value obtained by dividing the number of all points by the number of partial points is equal to or greater than a predetermined value which is greater than 1.

(5g) Functions of one component in the above-described embodiments may be distributed as a plurality of components, or functions of a plurality of components may be integrated into one component. Further, part of the configurations of the above-described embodiments may be omitted. Further, at least part of the configurations of the above-described embodiments may be added to or replaced with other configurations of the above-described embodiments.

What is claimed is:

1. An object detection device comprising:
an irradiation unit configured to irradiate a predetermined distance measurement area with light;
a light reception unit configured to receive reflected light of the light radiated by the irradiation unit and environment light; and
a detection unit configured to detect a predetermined object on a basis of a point group that is information based on the reflected light and an image,
wherein the point group is a group of reflection points detected in the whole distance measurement area,
the image is at least one of an environment light image that is an image based on the environment light, a distance image that is an image based on a distance to the object detected on a basis of the reflected light or a reflection intensity image that is an image based on reflection intensity of the reflected light, and
the detection unit is able to detect the object on a basis of the image having first resolution and the point group having first point group resolution indicating a number of units for detecting a plurality of the reflection points that constitute the point group and is able to detect the object on a basis of the image having second resolution higher than the first resolution and the point group having second point group resolution higher than the first point group resolution.

2. The object detection device according to claim 1,
wherein the light reception unit includes a plurality of light reception elements, and
the detection unit is able to switch resolution between the first resolution in which light reception elements of a first number among the plurality of light reception elements are made one pixel and the second resolution in which light reception elements of a second number smaller than the first number among the plurality of light reception elements are made one pixel.

3. The object detection device according to claim 1,
wherein the detection unit detects an image target that is a portion identified as the object in the image and generates a plurality of clusters by clustering the point group, and
in a case where it is determined that two or more clusters among the plurality of clusters exist in the portion in the point group, corresponding to the image target, or in a case where it is determined that a coupled cluster having a size larger than a size of the portion in the point group, corresponding to the image target among the plurality of clusters exists in the portion in the point group, corresponding to the image target, the detection unit switches resolution of the image from the first resolution to the second resolution, detects the image target, switches point group resolution of the point group from the first point group resolution to the second point group resolution and clusters the point group.

4. The object detection device according to claim 1,
wherein the detection unit is able to detect the object on a basis of the point group and the image having resolution different from point group resolution indicating a number of units for detecting a plurality of reflection points that constitute the point group.

5. The object detection device according to claim 4,
wherein the detection unit is able to detect the object on a basis of the point group and the environment light image having resolution different from the point group resolution of the point group.

6. The object detection device according to claim 1,
wherein the detection unit is able to detect the object on a basis of the environment light image having third resolution and at least one of the distance image or the reflection intensity image having fourth resolution different from the third resolution.

7. The object detection device according to claim 6,
wherein point group resolution indicating a number of units for detecting a plurality of the reflection points that constitute the point group matches resolution of at least one of the distance image or the reflection intensity image.

8. The object detection device according to claim 6, further comprising:
a brightness determination unit configured to determine outside brightness,
wherein in a case where it is determined by the brightness determination unit that outside brightness is brighter than a predetermined threshold, the detection unit detects the object on a basis of the environment light image having relatively higher resolution and at least one of the distance image or the reflection intensity image having relatively lower resolution than in a case where it is determined that outside brightness is not brighter than the predetermined threshold.

9. The object detection device according to claim 1,
wherein the irradiation unit is able to switch a number of times that at least part of a range in the distance measurement area is irradiated with light between a first number of times of irradiation and a second number of times of irradiation larger than the first number of times of irradiation.

10. The object detection device according to claim 9,
wherein the detection unit detects an image target that is a portion identified as the object in the image and generates a plurality of clusters by clustering the point group,
in a case where it is determined that two or more clusters among the plurality of clusters exist in the portion in the point group, corresponding to the image target or in a case where it is determined that an overcoupled cluster having a size larger than a size of the portion in the point group, corresponding to the image target among the plurality of clusters exists in the portion in the point group, corresponding to the image target, the irradiation unit switches a number of times of irradiation from the first number of times of irradiation to the second number of times of irradiation, and
in a case where a number of times of irradiation of light is switched from the first number of times of irradiation to the second number of times of irradiation, the detection unit detects the image target in the second number of times of irradiation and clusters the point group.

11. The object detection device according to claim 1,
wherein the detection unit detects an image target that is a portion identified as the object in the image, and in a case where it is determined that two or more clusters among a plurality of clusters generated by clustering the point group exist in a portion in the point group, corresponding to the image target, detects the two or more clusters as one object.

12. The object detection device according to claim 1,
wherein the detection unit detects an image target that is a portion identified as the object in the image, and in a case where it is determined that among the plurality of clusters generated by clustering the point group, an overcoupled cluster with a size larger than a size of the portion in the point group, corresponding to the image target exists in the portion in the point group, corresponding to the image target, separates the portion corresponding to the image target among the overcoupled cluster and detects the portion as the object.

13. The object detection device according to claim 12,
wherein the overcoupled cluster is divided so that a shortest distance between a target cluster that is the portion corresponding to the image target among the overcoupled cluster and an adjacent cluster that is a portion except the portion corresponding to the image target among the overcoupled cluster becomes greater than a maximum distance among distances between two adjacent points in the target cluster and becomes greater than a maximum distance among distances between two adjacent points in the adjacent cluster.

14. The object detection device according to claim 1,
wherein the detection unit detects an image target that is a portion identified as the object in the image, and in a case where it is determined that a size of the object falls within a range of a size set in advance in accordance with a type of the object indicated by the image target, detects the portion in the point group, corresponding to the image target, as the object.

15. The object detection device according to claim 1,
wherein the detection unit detects an image target that is a portion identified as the object in the image, and in a case where it is determined that a distance to the object falls within a range of a distance set in advance in accordance with a type of the object indicated by the image target, detects the portion in the point group, corresponding to the image target, as the object.

16. An object detection device comprising:
an irradiation unit configured to irradiate a predetermined distance measurement area with light;
a light reception unit configured to receive reflected light of the light radiated by the irradiation unit and environment light; and
a detection unit configured to detect a predetermined object on a basis of a point group that is information based on the reflected light and an image, wherein the point group is a group of reflection points detected in the whole distance measurement area,
the image is at least one of an environment light image that is an image based on the environment light, a distance image that is an image based on a distance to the object detected on a basis of the reflected light or a reflection intensity image that is an image based on reflection intensity of the reflected light, and
the detection unit is able to detect the object on a basis of the point group and the image having resolution different from point group resolution indicating a number of units for detecting a plurality of reflection points that constitute the point group.

17. The object detection device according to claim 16,
wherein the detection unit is able to detect the object on a basis of the point group and the environment light image having resolution different from the point group resolution of the point group.

18. The object detection device according to claim 16,
wherein the detection unit is able to detect the object on a basis of the environment light image having third resolution and at least one of the distance image or the reflection intensity image having fourth resolution different from the third resolution.

19. The object detection device according to claim 18,
wherein point group resolution indicating a number of units for detecting a plurality of the reflection points that constitute the point group matches resolution of at least one of the distance image or the reflection intensity image.

20. The object detection device according to claim 18, further comprising:
a brightness determination unit configured to determine outside brightness,
wherein in a case where it is determined by the brightness determination unit that outside brightness is brighter than a predetermined threshold, the detection unit detects the object on a basis of the environment light image having relatively higher resolution and at least one of the distance image or the reflection intensity image having relatively lower resolution than in a case where it is determined that outside brightness is not brighter than the predetermined threshold.

21. The object detection device according to claim 16,
wherein the irradiation unit is able to switch a number of times that at least part of a range in the distance measurement area is irradiated with light between a first number of times of irradiation and a second number of times of irradiation larger than the first number of times of irradiation.

22. The object detection device according to claim 21,
wherein the detection unit detects an image target that is a portion identified as the object in the image and generates a plurality of clusters by clustering the point group,
in a case where it is determined that two or more clusters among the plurality of clusters exist in the portion in the point group, corresponding to the image target or in a case where it is determined that an overcoupled cluster having a size larger than a size of the portion in the point group, corresponding to the image target among the plurality of clusters exists in the portion in the point group, corresponding to the image target, the irradiation unit switches a number of times of irradiation from the first number of times of irradiation to the second number of times of irradiation, and
in a case where a number of times of irradiation of light is switched from the first number of times of irradiation to the second number of times of irradiation, the detection unit detects the image target in the second number of times of irradiation and clusters the point group.

23. The object detection device according to claim 16,
wherein the detection unit detects an image target that is a portion identified as the object in the image, and in a case where it is determined that two or more clusters among a plurality of clusters generated by clustering the point group exist in a portion in the point group, corresponding to the image target, detects the two or more clusters as one object.

24. The object detection device according to claim 16,
wherein the detection unit detects an image target that is a portion identified as the object in the image, and in a case where it is determined that among the plurality of clusters generated by clustering the point group, an overcoupled cluster with a size larger than a size of the portion in the point group, corresponding to the image target exists in the portion in the point group, corresponding to the image target, separates the portion corresponding to the image target among the overcoupled cluster and detects the portion as the object.

25. The object detection device according to claim 24,
wherein the overcoupled cluster is divided so that a shortest distance between a target cluster that is the portion corresponding to the image target among the overcoupled cluster and an adjacent cluster that is a portion except the portion corresponding to the image target among the overcoupled cluster becomes greater than a maximum distance among distances between two adjacent points in the target cluster and becomes greater than a maximum distance among distances between two adjacent points in the adjacent cluster.

26. The object detection device according to claim 16,
wherein the detection unit detects an image target that is a portion identified as the object in the image, and in a case where it is determined that a size of the object falls within a range of a size set in advance in accordance with a type of the object indicated by the image target, detects the portion in the point group, corresponding to the image target, as the object.

27. The object detection device according to claim 16,
wherein the detection unit detects an image target that is a portion identified as the object in the image, and in a case where it is determined that a distance to the object falls within a range of a distance set in advance in accordance with a type of the object indicated by the image target, detects the portion in the point group, corresponding to the image target, as the object.

28. An object detection device comprising:
an irradiation unit configured to irradiate a predetermined distance measurement area with light;
a light reception unit configured to receive reflected light of the light radiated by the irradiation unit and environment light; and
a detection unit configured to detect a predetermined object on a basis of a point group that is information based on the reflected light and an image,
wherein the point group is a group of reflection points detected in the whole distance measurement area,
the image is at least one of an environment light image that is an image based on the environment light, a distance image that is an image based on a distance to the object detected on a basis of the reflected light or a reflection intensity image that is an image based on reflection intensity of the reflected light, and
the detection unit is able to detect the object on a basis of the environment light image having third resolution and at least one of the distance image or the reflection intensity image having fourth resolution different from the third resolution.

29. The object detection device according to claim 28,
wherein point group resolution indicating a number of units for detecting a plurality of the reflection points that constitute the point group matches resolution of at least one of the distance image or the reflection intensity image.

30. The object detection device according to claim 28, further comprising:
a brightness determination unit configured to determine outside brightness,
wherein in a case where it is determined by the brightness determination unit that outside brightness is brighter than a predetermined threshold, the detection unit detects the object on a basis of the environment light image having relatively higher resolution and at least one of the distance image or the reflection intensity image having relatively lower resolution than in a case where it is determined that outside brightness is not brighter than the predetermined threshold.

31. The object detection device according to claim 28,
wherein the irradiation unit is able to switch a number of times that at least part of a range in the distance measurement area is irradiated with light between a first number of times of irradiation and a second number of times of irradiation larger than the first number of times of irradiation.

32. The object detection device according to claim 31,
wherein the detection unit detects an image target that is a portion identified as the object in the image and generates a plurality of clusters by clustering the point group,
in a case where it is determined that two or more clusters among the plurality of clusters exist in the portion in the point group, corresponding to the image target or in a case where it is determined that an overcoupled cluster having a size larger than a size of the portion in the point group, corresponding to the image target among the plurality of clusters exists in the portion in the point group, corresponding to the image target, the irradiation unit switches a number of times of irradiation from the first number of times of irradiation to the second number of times of irradiation, and
in a case where a number of times of irradiation of light is switched from the first number of times of irradiation to the second number of times of irradiation, the detection unit detects the image target in the second number of times of irradiation and clusters the point group.

33. The object detection device according to claim 28,
wherein the detection unit detects an image target that is a portion identified as the object in the image, and in a case where it is determined that two or more clusters among a plurality of clusters generated by clustering the point group exist in a portion in the point group, corresponding to the image target, detects the two or more clusters as one object.

34. The object detection device according to claim 28,
wherein the detection unit detects an image target that is a portion identified as the object in the image, and in a case where it is determined that among the plurality of clusters generated by clustering the point group, an overcoupled cluster with a size larger than a size of the portion in the point group, corresponding to the image target exists in the portion in the point group, corresponding to the image target, separates the portion corresponding to the image target among the overcoupled cluster and detects the portion as the object.

35. The object detection device according to claim 34,
wherein the overcoupled cluster is divided so that a shortest distance between a target cluster that is the portion corresponding to the image target among the overcoupled cluster and an adjacent cluster that is a portion except the portion corresponding to the image target among the overcoupled cluster becomes greater than a maximum distance among distances between two adjacent points in the target cluster and becomes greater than a maximum distance among distances between two adjacent points in the adjacent cluster.

36. The object detection device according to claim 28,
wherein the detection unit detects an image target that is a portion identified as the object in the image, and in a case where it is determined that a size of the object falls within a range of a size set in advance in accordance with a type of the object indicated by the image target, detects the portion in the point group, corresponding to the image target, as the object.

37. The object detection device according to claim 28,
wherein the detection unit detects an image target that is a portion identified as the object in the image, and in a case where it is determined that a distance to the object falls within a range of a distance set in advance in accordance with a type of the object indicated by the image target, detects the portion in the point group, corresponding to the image target, as the object.

38. An object detection device comprising:
an irradiation unit configured to irradiate a predetermined distance measurement area with light;
a light reception unit configured to receive reflected light of the light radiated by the irradiation unit and environment light; and
a detection unit configured to detect a predetermined object on a basis of a point group that is information based on the reflected light and an image,
wherein the point group is a group of reflection points detected in the whole distance measurement area,
the image is at least one of an environment light image that is an image based on the environment light, a distance image that is an image based on a distance to the object detected on a basis of the reflected light or a reflection intensity image that is an image based on reflection intensity of the reflected light,
the irradiation unit is able to switch a number of times that at least part of a range in the distance measurement area is irradiated with light between a first number of times of irradiation and a second number of times of irradiation larger than the first number of times of irradiation,
the detection unit detects an image target that is a portion identified as the object in the image and generates a plurality of clusters by clustering the point group,
in a case where it is determined that two or more clusters among the plurality of clusters exist in the portion in the point group, corresponding to the image target or in a case where it is determined that an overcoupled cluster having a size larger than a size of the portion in the point group, corresponding to the image target among the plurality of clusters exists in the portion in the point group, corresponding to the image target, the irradiation unit switches a number of times of irradiation from the first number of times of irradiation to the second number of times of irradiation, and
in a case where a number of times of irradiation of light is switched from the first number of times of irradiation to the second number of times of irradiation, the detection unit detects the image target in the second number of times of irradiation and clusters the point group.

39. The object detection device according to claim 38,
wherein the detection unit detects an image target that is a portion identified as the object in the image, and in a case where it is determined that two or more clusters among a plurality of clusters generated by clustering the point group exist in a portion in the point group, corresponding to the image target, detects the two or more clusters as one object.

40. The object detection device according to claim 38,
wherein the detection unit detects an image target that is a portion identified as the object in the image, and in a case where it is determined that among the plurality of clusters generated by clustering the point group, an overcoupled cluster with a size larger than a size of the portion in the point group, corresponding to the image target exists in the portion in the point group, corresponding to the image target, separates the portion corresponding to the image target among the overcoupled cluster and detects the portion as the object.

41. The object detection device according to claim 40,
wherein the overcoupled cluster is divided so that a shortest distance between a target cluster that is the portion corresponding to the image target among the overcoupled cluster and an adjacent cluster that is a portion except the portion corresponding to the image target among the overcoupled cluster becomes greater than a maximum distance among distances between two adjacent points in the target cluster and becomes greater than a maximum distance among distances between two adjacent points in the adjacent cluster.

42. The object detection device according to claim 38,
wherein the detection unit detects an image target that is a portion identified as the object in the image, and in a case where it is determined that a size of the object falls within a range of a size set in advance in accordance with a type of the object indicated by the image target, detects the portion in the point group,
corresponding to the image target, as the object.

43. The object detection device according to claim 38,
wherein the detection unit detects an image target that is a portion identified as the object in the image, and in a case where it is determined that a distance to the object falls within a range of a distance set in advance in accordance with a type of the object indicated by the image target, detects the portion in the point group, corresponding to the image target, as the object.
